(19) United States
(12) Patent Application Publication
(10) Pub. No.: US 2022/0111915 A1
(43) Pub. Date: Apr. 14, 2022

(54) Articulated Lorry Having a Tractor and a Trailer, Tractor, Trailer and Method for Axle Load Distribution in the Case of an Articulated Lorry

(71) Applicant: Daimler AG, Stuttgart (DE)

(72) Inventors: Frank STEFFENS, Ostfildern (DE); Guenter KAYRAN, Ostfildern (DE)

(73) Assignee: Daimler AG, Stuttgart (DE)

(21) Appl. No.: 17/264,406

(22) PCT Filed: Jun. 7, 2019
(86) PCT No.: PCT/EP2019/064954

§ 371 Date: Jan. 29, 2021

(30) Foreign Application Priority Data
Aug. 1, 2018 (DE) 10 2018 006 103.6

(51) Int. Cl. B62D 53/06

(52) U.S. Cl. CPC B62D 53/068

(57) ABSTRACT

An articulated lorry that includes a tractor which has a fifth-wheel coupling and a trailer which has a connecting element which is reversibly detachably connected at a connection point to the fifth-wheel coupling. A tensioning device relieves a load on a wheel axle of the trailer, loads a drive axle of the trailer, and applies a force that counteracts a relative pivoting movement between the tractor and the trailer around a pivot axis which is oriented parallel to a transverse vehicle direction of the tractor and/or of the trailer. The tensioning device tensions the tractor to the trailer.

### BACKGROUND AND SUMMARY OF THE INVENTION

The invention relates to an articulated lorry, comprising a tractor which has a fifth-wheel coupling. The articulated lorry also comprises a trailer which has a connecting element which is reversibly detachably connected at a connection point to the fifth-wheel coupling. Further aspects of the invention relate to a tractor, a trailer and a method for axle load distribution in the case of an articulated lorry.

FIG. 1 shows a side view of a schematically depicted articulated lorry 100 known from prior art, in which a tractor 80 is coupled to a trailer 90 by means of a fifth-wheel coupling 86. The fifth-wheel coupling 86 fixed to the tractor 80 can have a similar structure as can be found, for example, in DE 103 55 558 A1. In the present case, the fifth-wheel coupling 86 has a coupling plate 87 on which a weight force component 91 of a weight force of the trailer 90 is supported. The trailer 90 can be coupled to the fifth-wheel coupling 86 by means of a king pin of the trailer 90 which is not shown in more detail. The fifth-wheel coupling 86 further comprises a bearing block 88 and a pivot bearing 89, via which the coupling plate 87 is pivotally coupled to the bearing block 88. The bearing block 88 is fixed to a structure of the tractor 80. The pivot bearing 89 serves as a so-called folding compensation and enables a relative tilting between the tractor 80 and the trailer 90. This relative tilting can occur, for example, when the articulated lorry 100 drives over uneven ground. Such uneven ground can occur in particular when the articulated lorry 100 is used on construction sites, i.e., in so-called construction use of the articulated lorry 100. In addition, when the articulated lorry 100 is used on construction sites, it is sometimes moved on unsurfaced terrain, i.e.,—depending on the weather conditions—muddy or even icy ground 92. In an unloaded or barely loaded state, the trailer 90 has a low total weight, as a result of which the weight force component 91 is also correspondingly low. As a result, a first axle load 82 of a steering axle 81 of the tractor 80 can be significantly greater than a second axle load 84 on a drive axle 83 of the tractor 80 coupled to the trailer 90, particularly since the drive axle 83—in addition to a portion of the weight of the tractor 80—is only slightly additionally loaded by the weight force component 91. If the coefficient of friction between the ground 92 and the respective drive wheels assigned to the drive axle 83 is low, this can lead to slippage 85, i.e., to slipping of the drive wheels and, as a result, to the tractor 80 and thus the entire articulated lorry 100 getting stuck. To counter this problem, the tractor 80 can, for example, be equipped with an all-wheel drive or with a hydraulic auxiliary drive, by means of which, for example, respective wheels assigned to the steering axle 81 (here: front axle) can be driven. The hydraulic auxiliary drive can be used to drive the front wheels assigned to the steering axle 81 in order to be able to move the articulated lorry 100 if it gets stuck. Equipping the articulated lorry 100 with a trailing or leading axle or with a tandem axle system in which a lift axle of the tandem axle system can be raised in order to additionally load the drive axle 83 is also one of the known measures for reducing the slip 85 and achieving improved grip of the drive wheels. However, the known measures can often only be implemented with a high mechanical effort and lead to a sometimes significant increase in the total weight of the articulated lorry 100. Just like the increase in the total weight, an increased towing power by respective aggregates of these known measures (all-wheel drive, hydraulic auxiliary drive, lift axle) can also lead to an additional consumption of fuel of an internal combustion engine of the tractor 80. These aggregates include, for example, hydraulic pumps and hydraulic motors on the drive axle or on the drive wheels.

The object of the present invention is to provide an articulated lorry, a tractor, a trailer and a method of the type mentioned above, by means of which improved propulsion can be achieved with little effort by improved power transmission from driven wheels.

This object is solved according to the invention by an articulated lorry, by a tractor, by a trailer, and by a method. Statements about one of the aspects of the invention, in particular about individual features of this aspect, also apply correspondingly by analogy to the other aspects of the invention and vice versa.

A first aspect of the invention relates to an articulated lorry, comprising a tractor, which has a fifth-wheel coupling, and a trailer, which has a connecting element and which is reversibly detachably connected to the fifth-wheel coupling at a connection point. The trailer can also be referred to as a semi-trailer. The connection point can be a common connection point of the tractor and the trailer.

According to the invention, the articulated lorry comprises means for relieving at least one wheel axle of the trailer and for loading at least one drive axle of the tractor, and a force can be applied by the means to counteract a relative pivoting movement between the tractor and the trailer around a pivot axis which is oriented parallel to a transverse vehicle direction of the tractor and/or the trailer. This is advantageous, since by these means, an axle load distribution is thus enabled at least between the at least one wheel axle of the trailer and the at least one drive axle of the tractor, and the relative pivoting movement can be impeded by applying the force. The pivot axis can, for example, extend through a swivel joint of the fifth-wheel coupling. The transverse vehicle direction of the tractor can correspond to the transverse vehicle direction of the trailer.

The means can be used, for example, to cause a tensioning of the trailer counteracting the pivoting movement relative to the tractor. For this purpose, the means can, for example, block the pivoting movement with little effort. Simultaneously or subsequently, the loading of the drive axle of the tractor on the one hand and the unloading of the wheel axle of the trailer on the other hand can occur due to these means. To achieve this, the means can be used, for example, to change the height, i.e., to change a distance between at least one axle of the articulated lorry and a partial region of a structure of the articulated lorry lying above this axle in the vertical direction of the vehicle in such a way that the drive axle is subjected to a greater weight load than before, such that the axle load is distributed accordingly to the drive axle. This can result in an increase in axle load on the drive axle. As an alternative to the drive axle, the axle can be a steering axle of the tractor or the wheel axle of the trailer. By way of example, the means can be used to relieve the load on the steering axle of the tractor and the wheel axle of the trailer and to load the drive axle, to name just one example. It is conceivable, for example, to relieve the load on the steering axle of the tractor in such a way that respective wheels assigned to the steering axle and which are thus steerable are lifted off the ground in order to relieve the load on the steering axle to a maximum, i.e., completely, and at the same time to place a particularly high load on the drive axle. The means can additionally or alternatively also be used, for example, to change the distance between the at least one drive axle and a body of the tractor in the vehicle vertical direction of the tractor. As a result, for example, a partial area of the articulated lorry arranged above the drive axle in the vertical direction of the vehicle can be raised and, in conjunction with the tensioning of the trailer relative to the tractor, a weight force portion of a weight force of the trailer, which can also be referred to as the trailer weight force, can be shifted overall to the drive axle of the tractor in order to cause the axle load increase and, as a result, the improved force transmission to the ground. In this way, the load on the wheel axle can be relieved and, at the same time, the load on the drive axle can be effected. Due to this load on the drive axle, respective wheels of the drive axle can have an increased load, whereby the wheels can be driven under reduced slip. The driven wheels of the drive axle therefore spin less as a result of the use of the means than they did before the use of the means, such that overall a low-effort, improved propulsion can be achieved by improved power transmission of the driven wheels.

The means can, for example, comprise an actuator, by means of which the distance between at least one of the axles (steering axle, drive axle, wheel axle) and the body of the articulated lorry can be adjusted. The actuator can be used in a particularly demand-oriented manner, such that it can contribute in a particularly advantageous way to a low-effort, improved propulsion of the driven wheels by means of targeted axle load distribution, and in addition, costly aggregates known from the prior art can be dispensed with.

The means can be generally controllable and thus switchable between a respective active state and a respective passive state. This means that the means can be switched on or off as required. In contrast to the passive state, in the active state the relief of the at least one wheel axle of the trailer as well as the loading of the at least one drive axle of the tractor can take place. Moreover, in contrast to the passive state, in the active state, the means can counteract the relative pivoting movement between the tractor and the trailer around the pivot axis. The articulated lorry can comprise at least one control device for switching the means between their respective active state and their respective passive state. The at least one control device can be associated with the tractor or the trailer.

In an advantageous development of the invention, the means comprise at least one tensioning device, by means of which the tractor can be tensioned with the trailer and thereby the force counteracting the relative pivoting movement can be applied. This is advantageous, since the tensioning device can effect a particularly low-effort impeding of the relative pivot movement, whereby the loading of the drive axle of the tractor and the unloading of the wheel axle of the trailer is made possible with particularly low effort. The at least one bracing device can preferably be integrated in the fifth-wheel coupling, whereby a particularly compact arrangement of the tensioning device is enabled.

In a further advantageous development of the invention, the at least one tensioning device is designed to apply a torque acting around the connection point for relieving the load on the at least one wheel axle of the trailer and for loading the at least one drive axle of the tractor. This is advantageous because the tensioning device can thus not only counteract the relative pivot movement, but can also relieve the load on the wheel axle of the trailer and load the drive axle of the tractor by applying the torque. By applying the torque, active pivoting can be achieved between the trailer and the tractor, and thereby relieving the load on the wheel axle of the trailer and loading the drive axle of the tractor. Such a design of the tensioning device gives it a particularly high level of functionality. Due to the possibility of applying the torque, the tensioning device can, in a particularly advantageous manner, relieve the load on the wheel axle of the trailer and load the drive axle of the tractor even if the tractor and the trailer do not comprise any further actuators which contribute to the axle load distribution. The torque can generally act around the connection point, as well as around the pivot axis. A lever arm of the torque can correspond to a distance between the connection point and an engagement point of the tensioning device. The engagement point can correspond to a point at which the force causing the torque and exertable by means of the tensioning device can act.

In a further advantageous development of the invention, it is provided that the at least one tensioning device is arranged in the longitudinal direction of the vehicle of the tractor between a driver's cab of the tractor and the connecting point or that the connecting point is arranged in the longitudinal direction of the vehicle of the tractor between a driver's cab of the tractor and the at least one tensioning device. This is advantageous because, in the case of both alternatives, it is particularly easy to exert the force under an at least substantially linear force flow, for example along the vertical direction of the vehicle, in order to bring about the relief of the wheel axle as well as the loading of the drive axle. If the tensioning device is arranged in the longitudinal direction of the tractor and the connection point, the force can be exerted as a tensile force acting between the tractor and the trailer, by means of which the relief of the wheel axle (of the trailer) and the loading of the drive axle (of the tractor) is made possible. If, on the other hand, the connection point is arranged in the longitudinal direction of the tractor between a driver's cab of the tractor and the at least one tensioning device, the force can be exerted as a compressive force acting between the tractor and the trailer, by means of which the relief of the wheel axle (of the trailer) and the loading of the drive axle (of the tractor) is made possible.

In a further advantageous development of the invention, the at least one tensioning device comprises a roller arrangement via which the at least one tensioning device can be supported in a rollable manner relative to the tractor or relative to the trailer when the force is applied. This is advantageous because the roller arrangement allows the tensioning device to roll at least in certain areas relative to the tractor or relative to the trailer, as a result of which, for example, a steering movement can be carried out with particularly low resistance, even if the force is exerted by the tensioning device during the steering movement.

It is conceivable, for example, that the tensioning device can be fixed to the tractor on the one hand and the roller arrangement can be arranged at an end of the tensioning device facing the trailer. In order to exert the force by means of the tensioning device, for example as a tractive force between the trailer and the tractor, the roller arrangement or respective rollers of the roller arrangement can be suspended, for example, on a guide rail arranged on the trailer. For this purpose, the roller arrangement can engage behind the guide rail, for example, and roll on the guide rail. The roller arrangement can roll on the guide rail in an arc, for example, such that the roller arrangement can roll with low friction in accordance with respective steering movements. It is clear that the bracing device for exerting the force as a tractive force can also be fixed to the trailer and the roller arrangement can be arranged at another end of the tensioning device facing the tractor. In this case, the guide rail can be arranged on the tractor.

In order to exert the force as a compressive force between the trailer and the tractor by means of the tensioning device, the roller arrangement can, for example, roll on a bearing surface of the tractor or the trailer with particularly low effort.

In a further advantageous development of the invention, the at least one tensioning device is arranged in the vehicle vertical direction of the tractor at least in regions below a coupling plate of the fifth-wheel coupling. This is advantageous, since the force can thereby be exerted between the coupling plate and the tractor or a body of the tractor, such that a direct transmission of the force to the trailer can be omitted. The at least one tensioning device can thus be arranged in the vehicle vertical direction of the tractor at least in regions below the coupling plate of the fifth-wheel coupling in order to exert the force on the coupling plate. The at least one tensioning device can preferably be arranged in the vehicle vertical direction between the coupling plate and a frame of the tractor. The frame can be allocated to the body of the tractor. The described arrangement of the tensioning device means that a specially provided contact area for direct coupling or support of the tensioning device on the trailer can be dispensed with. Accordingly, there is no need for a complex modification of the trailer.

In a further advantageous development of the invention, the means comprise at least one height-changing device, by means of which a distance in the vehicle vertical direction of the tractor between at least one partial region of a body of the articulated lorry and at least one wheel of the articulated lorry can be adjusted. This is advantageous because it allows the relative pivoting movement to be blocked in a particularly simple manner, in that the means comprise, for example, a particularly simply constructed coupling rod which can be coupled to the tractor on the one hand and to the trailer on the other hand in order to counteract the relative pivoting movement. Subsequently, the height-changing device can be used to relieve the load on the wheel axle and to load the drive axle. The at least one height-changing device can be assigned to the tractor. The at least one height-changing device can also be assigned to the trailer. In addition, it is conceivable that the tractor and the trailer are each assigned a height-changing device, i.e., that the tractor comprises a first height-changing device and the trailer comprises a second height-changing device.

The corresponding height-changing device can preferably be designed as an active chassis and comprise, for example, an air suspension. The active chassis or the air suspension allows the trailer to be uncoupled and coupled in a particularly simple and uncomplicated manner.

A second aspect of the invention relates to a tractor having a fifth-wheel coupling which can be reversibly detachably connected at a connection point to a connection element of a trailer. According to the invention, the tractor comprises means for relieving at least one wheel axle of the trailer and for loading at least one drive axle of the tractor, and by the means a force can be applied which counteracts a relative pivoting movement between the tractor and the trailer around a pivot axis which is oriented parallel to a transverse vehicle direction of the tractor. In particular, the tractor can be configured for an articulated lorry in accordance with the first aspect of the invention. In other words, the tractor can be designed as a tractor of an articulated lorry according to the first aspect of the invention. By means of this tractor, improved propulsion can be achieved with low effort by improved transmission of power from driven wheels.

A third aspect of the invention relates to a trailer which has a connection element which can be reversibly detachably connected at a connection point to a fifth-wheel coupling of a tractor. According to the invention, the trailer comprises means for relieving at least one wheel axle of the trailer and for loading at least one drive axle of the tractor, and a force can be applied by the means, which counteracts a relative pivoting movement between the tractor and the trailer around a pivot axis which is oriented parallel to a transverse vehicle direction of the trailer. In particular, the trailer can be configured for an articulated lorry in accordance with the first aspect of the invention. In other words, the trailer can be designed as a trailer of an articulated lorry according to the first aspect of the invention. By means of this trailer, improved propulsion can be achieved with low effort by improved transmission of power from driven wheels.

A fourth aspect of the invention relates to a method for axle load distribution in the case of an articulated lorry, which comprises a tractor which has a fifth-wheel coupling, and which comprises a trailer which has a connecting element which is reversibly detachably connected at a connection point to the fifth-wheel coupling. According to the invention, the articulated lorry comprises means by which at least one wheel axle of the trailer is relieved and at least one drive axle of the tractor is loaded and by means of which a force is applied which counteracts a relative pivoting movement between the tractor and the trailer around a pivot axis which is oriented parallel to a transverse vehicle direction of the tractor and/or the trailer.

Preferably, the means can lift at least one steerable wheel of a front axle of the trailer off a road surface in order to load the at least one drive axle of the tractor. This is advantageous, since a particularly strong load can be applied to the drive axle by relieving the front axle, whereby wheels associated with the drive axle can be driven with particularly good road grip.

Preferably, the tractor can comprise at least one steering brake, by means of which the tractor is steered while the at least one steerable wheel is raised from the road surface. This is advantageous because the steering brake enables the tractor and thus the articulated lorry to be steered even when the load on the at least one steerable wheel is completely relieved. As a result, even on very icy ground, not only improved propulsion of the articulated lorry but also its change of direction can be achieved by steering.

Further advantages, features and details of the invention emerge from the following description of a preferred exemplary embodiment and from the drawing. The features and combinations of features mentioned above in the description, as well as the features and combinations of features mentioned below in the description of the figure and/or shown in the figure alone can be used not only in the combination specified in each case, but also in other combinations or on their own, without leaving the scope of the invention.

### BRIEF DESCRIPTION OF THE DRAWINGS

FIG. 1 is a schematic side view of an articulated lorry known from the prior art; and

FIG. 2 is a schematic side view of an articulated lorry which comprises means to relieve the load of at least one wheel axle of a trailer and to load at least one drive axle of the tractor.

### DETAILED DESCRIPTION OF THE DRAWINGS

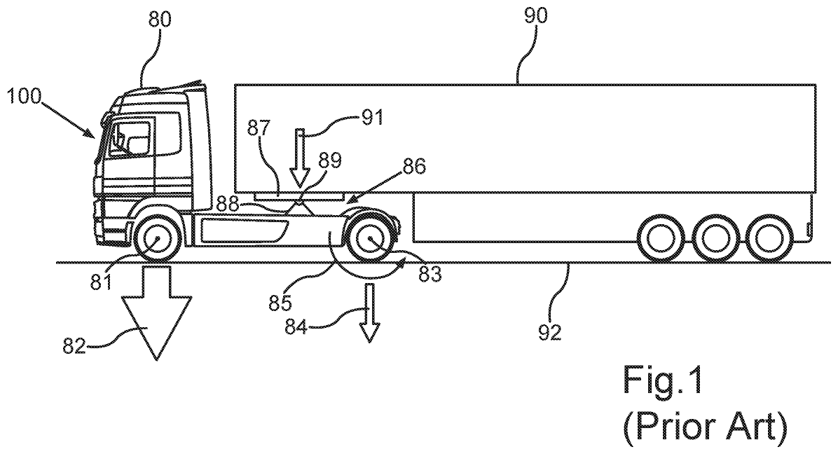

With regard to FIG. 1, reference is made here to the statements in the introductory part of the description.

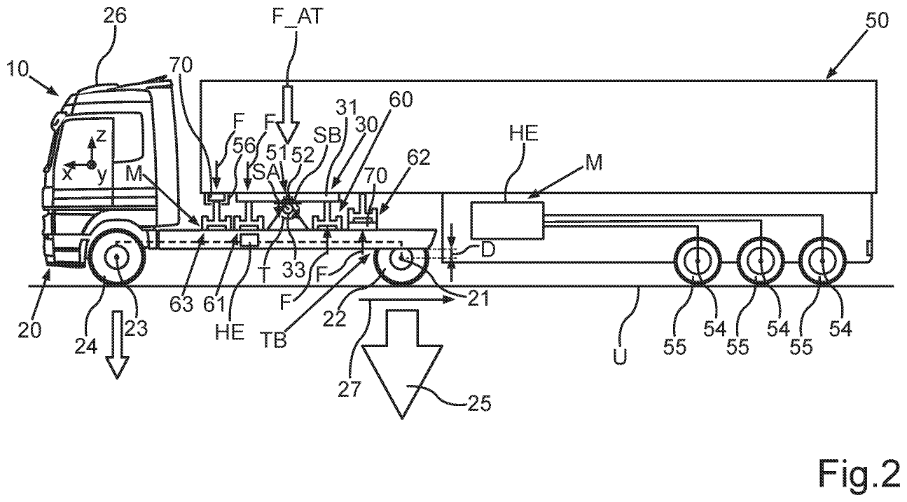

FIG. 2 shows an articulated lorry 10, which comprises a tractor 20 and a trailer 50, as well as a coordinate system related to the articulated lorry 10, the coordinate system being defined by a longitudinal vehicle direction x, a transverse vehicle direction y and a vertical vehicle direction z. The longitudinal vehicle direction x, the transverse vehicle direction y and the vertical vehicle direction z can be related to both the tractor 20 and to the trailer 50, since respective longitudinal axes of the tractor 20 and of the trailer 50, which are not shown separately here, are oriented parallel to each other or aligned with each other. Such an orientation of the longitudinal axes results, for example, from a longer straight travel line of the articulated lorry 10.

The trailer 20 comprises a front axle designed as a steering axle 23, having steerable wheels 24 and a drive axle 21 having drivable wheels 22. By means of the wheels 22, 24, the tractor 20 is supported with respect to an underlying surface U. The wheels 22 can be driven, for example, by means of an internal combustion engine, not depicted in more detail here, of the tractor 20. The tractor 20 also has a fifth-wheel coupling 30.

The trailer 50 has a connecting element 52, designed as a king pin in the present case, which is reversibly detachably connected to the fifth-wheel coupling 30 at a common connection point 51.

The articulated lorry 10 comprises means M for relieving the load on respective wheel axles 54 of the trailer 50 and for loading the drive axle 21 of the tractor 20. Respective wheels 55 of the trailer 50 are fixed to the wheel axles 54, by means of which respective wheels the trailer 50 is supported relative to the ground U.

At least one force F, illustrated by an arrow in FIG. 2, can be applied by the means M, which counteracts a relative pivoting movement SB between the tractor 20 and the trailer 50 around a pivot axis SA. In the present case, the pivot axis SA is oriented parallel to the transverse vehicle direction y of the tractor 20 and the trailer 50. The means M can be switched between a respective active state and a respective passive state by means of a control unit of the tractor 20 or of the trailer 50, which is not depicted in more detail here.

In the present case, the pivot axis SA extends through a swivel joint 33 of the fifth-wheel coupling 30. A coupling plate 31 of the fifth-wheel coupling 30 is rotatably coupled to a coupling base body 32 of the fifth-wheel coupling 30 by the swivel joint 33. The coupling base body 32 is fixed to a frame and thus to a body of the tractor 20. The coupling plate 31 can be designed for at least indirect reversibly detachable connection to the connecting element 52 (king pin).

The means M comprise tensioning devices 60, 61, 62, 63, by means of which the tractor 20 can be tensioned with the trailer 50 and the force F counteracting the relative pivoting movement SB can thereby be applied. In FIG. 2, a total of four of the tensioning devices 60, 61, 62, 63 are shown, each of which is capable of applying the force F. Thus, already one of the tensioning devices 60, 61, 62, 63 is sufficient to exert the force F. However, FIG. 2 serves to depict various possibilities for the arrangement of the respective tensioning devices 60, 61, 62, 63. In the present case, the tensioning devices 60, 61, 63 are assigned to the tractor 20, whereas the tensioning device 62 is assigned to the trailer 50. In other words, the tractor 20 comprises the tensioning devices 60, 61, 63 and the trailer 50 comprises the tensioning device 62.

The tensioning devices 60, 61 are arranged in the vertical vehicle direction z below the coupling plate 31 of the fifth-wheel coupling 30. In contrast, the tensioning devices 62, 63 are each arranged adjacent to the coupling plate 31 in the vehicle longitudinal direction x. The tensioning devices 60, 61, 62, 63 can be actuated mechanically, electrically and additionally or alternatively hydraulically. The tensioning devices 60, 61, 62, 63 can each be designed to be telescopic. For this purpose, the tensioning devices 60, 61, 62, 63 can comprise, for example a threaded spindle, a hydraulic cylinder or a pneumatic cylinder.

Preferably, the tensioning devices 60, 61, 62, 63 can be self-locking in their respective active state. This means that—depending on the design of the tensioning devices 60, 61, 62, 63—there is no need for a power supply or for pressurised hydraulic fluid or pressurised gas in the active state, which enables particularly energy-saving operation of the tensioning devices 60, 61, 62, 63 as required.

In the present case, the tensioning devices 61, 63 are arranged in the longitudinal vehicle direction x of the tractor 20 between a driver's cab 26 of the tractor 20 and the connection point 51.

If one of the two tensioning devices 61, 63 is shifted from its passive state to its active state, the respective tensioning device 61, 63 exerts the force F as a tensile force, by means of which the trailer 50 is pulled in the direction opposite to an arrow direction of the vertical vehicle direction z and thus in the direction of the tractor 20, as can be seen from FIG. 2.

The tensioning device 63, which is connected on the one hand to the frame and thus to the body of the tractor 20, can be coupled to a guide rail 56 arranged on the trailer 50 and can thus engage or hook behind the guide rail 56 in order to exert the force F as a tensile force. The tensioning devices 62, 63 each comprise a roller arrangement 70, via which the tensioning devices 62, 63 can be supported in a rollable manner relative to the tractor 20 or relative to the trailer 50 when the force F is applied. In FIG. 2, it can be seen that the tensioning device 63 is hooked behind, i.e., coupled to the guide rail 56 via the roller arrangement 70, such that the tensioning device 63 can roll on the guide rail 56 when the force F is applied via the roller arrangement 70, for example when the articulated lorry 10 changes from straight-ahead travel to cornering or vice versa. The tensioning device 62 can, for example, be fixed to the trailer 50 and, when the force F is applied via its roller arrangement 70, roll on the frame and thus on the body of the tractor 20 when the articulated lorry 10 changes from straight-ahead travel to cornering or vice versa.

Furthermore, the connection point 51 is arranged in the longitudinal vehicle direction x of the tractor 20 or of the trailer 50 between the driver's cab 26 of the tractor 20 and the tensioning devices 60, 62. The tensioning devices 60, 62 can exert the force F in their respective active state as a compressive force oriented in the direction of the arrow of the vertical vehicle direction z.

All tensioning devices 60, 61, 62, 63 are designed to apply, in their respective active state, a torque T acting around the connecting point 51, as illustrated in the present case by a curved arrow, to relieve the load on the wheel axles 54 of the trailer 50 and to simultaneously load the drive axle 21 of the tractor 20. The torque T acts, when the articulated lorry 10 is travelling straight ahead, around the pivot axis SA oriented in the transverse vehicle direction y, or around the connection point 51.

Furthermore, in the present case, the means M comprise two height-changing devices HE, of which one height-changing device HE is assigned to the tractor 20 and of which another height-changing device HE is assigned to the trailer 50. By means of the height-changing devices HE, in each case a distance D in the vehicle vertical direction z of the tractor 20 or of the trailer 50 between at least one partial region TB of a body of the articulated lorry 10 and at least one of the wheels 22, 24 or 55 of the articulated lorry 10 can be adjusted. The height-changing devices HE can also be switched from their respective passive state to their respective active state by means of the control device. In the present case, the height-changing devices HE are designed as a respective active chassis of the tractor 20 or the trailer 50. To adjust the distance D, just one of the height-changing devices HE can be sufficient.

By applying the torque T and additionally or alternatively by applying the force F in conjunction with changing the distance D by means of at least one of the height changing devices HE, a weight force component F_AT of the trailer 50 can be at least partially displaced from the wheel axles 54 and thus from the respective wheels 55 in the longitudinal vehicle direction x and thus in the direction of the swivel joint 33 or the connection point 51. This results in a relief of the wheel axles 54 and, at the same time, in a loading of the drive axle 21 of the tractor 20. An axle load increase 25 is thus effected at the drive axle 21, such that an improved power transmission 27 can be effected with particularly low slip between the respective wheels 22 of the drive axle 21 and the ground U even if the trailer 50 is unloaded and the trailer 50 accordingly has a low trailer weight force and exerts it on the ground U. Thus, the means 10 enable an overall improved traction, i.e., reduced slip due to the axle load increase 25, i.e., the load on the drive axle 21.

For axle load distribution in the articulated lorry 10, switching the respective means M to their respective active state M can relieve the load on the wheel axles 54 of the trailer 50 as well as load the drive axle 21 of the trailer 20 and apply the force F which counteracts the relative pivoting movement SB between the tractor 20 and the trailer 50 around the pivot axis SA.

In summary, in the articulated lorry 10, which comprises the tractor 20 and the trailer 50, the axle load increase 25 can be effected on the drive axle 21 to counteract poor traction conditions of the driveable wheels 22 on the ground U due to wetness or ice despite the low trailer weight force. By means of the articulated lorry 10 or the tractor 20 or the trailer 50, slippage, i.e., excessive slippage of the driveable wheels 22, can thus be counteracted and a grip of the wheels 22 on the ground can be improved. As a result, costly aggregates, for example of an all-wheel drive or of a hydraulic auxiliary drive, can be dispensed with and costly towing activities can be dispensed with even when the articulated lorry 10 is used on a construction site where the ground U may be unsurfaced.

Just one of the described tensioning devices 60, 61, 62, 63 is sufficient to apply the torque T or apply the force F via the swivel joint 33, which enables folding compensation between the tractor 20 and the trailer 50, in particular in the transverse vehicle direction y. As a result, the axle load increase 25, which can also be referred to as axle load lifting, can be effected at the drive axle 21, whereby an improved ground adhesion and thus an improved adhesive force between the driveable wheels 22 and the ground U can be achieved. As a result, it is possible to move the articulated lorry 10 even when the ground U is icy, wet or muddy.

Depending on the arrangement of the respective tensioning device 60, 61, 62, 63, the force F can be exerted as a tensile force or as a compressive force. Although not shown further in FIG. 2, one of the tensioning devices 60, 61, 62, 63 could also apply the torque T directly to the swivel joint 33.

By means of the tensioning devices 60, 61, 62, 63, it is possible to block the relative pivoting movement SB via the swivel joint 33 and to effect the axle load increase 25 by changing the distance D between at least the partial area TB of the body of the articulated lorry 10 and at least one of the wheels 22, 24, 55 of the articulated lorry 10, wherein the change of the distance D can already be effected by merely one of the height-changing devices HE. The blocking can be effected directly at the swivel joint 33 by locking by means of the tensioning devices 60, 61, 62, 63 or by using the tensioning devices 60, 61, 62, 63 as spacers, wherein even small actuating forces can be sufficient to switch the respective tensioning devices 60, 61, 62, 63 between their passive state and their active state. If the pivoting movement SB is blocked, the axle load distribution of the articulated lorry 10 can be changed by changing the distance D, thus causing the axle load increase 25. Exceeding the axle load limit values can be excluded, since the height-changing devices HE, which can comprise an air suspension, can be designed for the corresponding axle load increase 25.

By means of the present articulated lorry, the tractor 20 and/or the trailer 50, a starting aid for moving the articulated lorry 10 on unsurfaced ground U can be provided by the targeted axle load increase 25 occurring at the drive axle 21 of the tractor 20.

By applying the torque T and additionally or alternatively by applying the force F in conjunction with changing the distance D by means of at least one of the height-changing devices HE, the tractor 20 and the trailer 50 can be kept angled at least slightly relative to one another in a plane spanned in FIG. 2 by the vehicle longitudinal direction x and the vehicle vertical direction z, as a result of which the axle load increase 25 can be effected.

The tractor 20, which is coupled to the trailer 50 via the fifth-wheel coupling 30, can first be lowered at the partial area TB and thus at the drive axle 21 by means of the height-changing device HE associated with the tractor 20 (by switching the height-changing device HE from its passive state to its active state), for example. As a result, the distance D between the partial area TB of the body and the driveable wheels 22 can firstly be reduced and the tractor 20 can be angled relative to the trailer 50. Subsequently, the force F and additionally or alternatively the application of the torque T can be effected by at least one of the tensioning devices 60, 61, 62, 63, whereby the pivoting movement SB can be prevented or blocked. Subsequently, the distance D can be increased again in order to thereby effect the loading of the drive axle 21, i.e., the axle load increase 25 as well as the unloading of the wheel axles 54 of the trailer 50.

1.-9. (canceled)

10. An articulated lorry, comprising:
a tractor which has a fifth-wheel coupling;
a trailer which has a connecting element which is reversibly detachably connected at a connection point to the fifth-wheel coupling; and
means for relieving a load on a wheel axle of the trailer and for loading a drive axle of the trailer and for applying a force that counteracts a relative pivoting movement between the tractor and the trailer around a pivot axis which is oriented parallel to a transverse vehicle direction of the tractor and/or of the trailer;
wherein the means comprise a tensioning device that tensions the tractor to the trailer to apply the force.

11. The articulated lorry according to claim 10, wherein the tensioning device applies a torque acting around the connection point that relieves the load on the wheel axle of the trailer and that loads the drive axle of the trailer.

12. The articulated lorry according to claim 10, wherein the tensioning device is disposed in a longitudinal vehicle direction of the tractor between a driver cab of the tractor and the connection point or wherein the connection point is disposed in the longitudinal vehicle direction of the tractor between the driver cab and the tensioning device.

13. The articulated lorry according to claim 10, wherein the means comprise a roller, wherein the tensioning device is supportable in a rollable manner with respect to the tractor or with respect to the trailer by the roller when the force is applied.

14. The articulated lorry according to claim 10, wherein the tensioning device is disposed in a vehicle vertical direction of the tractor at least in a region below a coupling plate of the fifth-wheel coupling.

15. The articulated lorry according to claim 10, wherein the means comprise a height-changing device, wherein a distance in a vehicle vertical direction of the tractor between a partial region of a body of the articulated lorry and a wheel of the articulated lorry is adjustable by the height-changing device.

16. An apparatus, comprising:
means for relieving a load on a wheel axle and for loading a drive axle and for applying a force that counteracts a relative pivoting movement between a tractor and a trailer around a pivot axis which is oriented parallel to a transverse vehicle direction of the tractor and/or of the trailer;
wherein the means comprise a tensioning device that tensions the tractor to the trailer to apply the force.

17. A method for axle load distribution in an articulated lorry which includes a tractor which has a fifth-wheel coupling and which includes a trailer which has a connecting element which is reversibly detachably connected at a connection point to the fifth-wheel coupling, comprising the steps of:
relieving a load on a wheel axle of the trailer, loading a drive axle of the trailer, and applying a force that counteracts a relative pivoting movement between the tractor and the trailer around a pivot axis which is oriented parallel to a transverse vehicle direction of the tractor and/or of the trailer by a tensioning device that tensions the tractor to the trailer.
